(19) United States
(12) Patent Application Publication
(10) Pub. No.: US 2014/0202430 A1
(43) Pub. Date: Jul. 24, 2014

(54) DUAL FUEL SYSTEM FOR AN INTERNAL COMBUSTION ENGINE

(71) Applicant: Serge V. Monros, Santa Ana, CA (US)

(72) Inventor: Serge V. Monros, Santa Ana, CA (US)

(21) Appl. No.: 14/156,204

(22) Filed: Jan. 15, 2014

Related U.S. Application Data
(60) Provisional application No. 61/754,683, filed on Jan. 21, 2013.

(51) Int. Cl. F02M 21/02; F02M 43/00

(52) U.S. Cl. CPC F02M 21/0236; F02M 43/00
USPC 123/445; 123/525

(57) ABSTRACT

A dual fuel system for a vehicle utilizing gasoline and propane fuel sources. The dual fuel system includes a micro-controlled switch box that switches back and forth between fuels. A fuel injector rail and fuel injectors are also included that can function to inject either gasoline or propane. A display and selector switch are also provided inside the cabin of the vehicle to allow the user to read system information and manually select a type of fuel.

### FIELD OF THE INVENTION

The present invention generally relates to fuel systems for an internal combustion engine. More particularly, the present invention relates to a dual fuel system for an internal combustion engine that utilizes both gasoline and propane.

### BACKGROUND OF THE INVENTION

It is estimated that there are currently 300 million vehicles on America's roads. Every day, the average American spends almost an hour driving in a car. Additionally, approximately 70% of goods that are shipped in America travel on commercial vehicles. Clearly, automobiles are an integral part of everyday life in America. The same is true for most countries around the world.

The world's dependence on automobiles creates a similar dependence on fuel sources to power those automobiles. Most vehicles on the roads today are fueled by gasoline or diesel fuel. Our need for these fossil fuels, however, creates a host of problems. First (and most notably) is cost. Rising prices at the gas pump is a frequent source of concern and contention in America. Gasoline and diesel prices seem to fluctuate on a daily basis, but there is a definite upward trend in fuel pricing. A decade ago, gas prices averaged about $1 per gallon in the United States. Today, the average price per gallon in America is close to $4. And there are no indicators to suggest that gas prices will go down in the foreseeable future.

Another problem our need for fossil fuels gives rise to is pollution. According to the United States Environmental Protection Agency (EPA), an average car produces over 600 pounds of air pollution every day. These air pollutants include: carbon monoxide, nitrogen dioxide, particulate matter, ozone, sulfur dioxide, and lead. All these pollutants are known sources of a wide variety of health problems in humans, as well as ozone depletion and acid rain in the environment. Many speculate that air pollution is also causing the gradual and irreversible warming of the globe. Transportation sources now account for 77% of national total carbon monoxide emissions. Approximately 3.8 grams of volatile organic compounds (another harmful source of pollution) are emitted by every car every day, even when the car is not driven.

Increases in vehicular pollution have in turn given rise to numerous governmental attempts at regulating the source of the pollution. One of the most notable of these attempts is called “The Clean Air Act”. The Clean Air Act was passed by Congress in 1970, and most recently amended in 1990. This act sets air quality standards for emissions from area, stationary, and mobile sources. It states that the EPA is authorized to set National Ambient Air Quality Standards which protect human health and the environment. The Air Quality Standards set by the EPA are monitored across the country and enforced via testing, reporting, fines, and even law suits. Individual states also have their own environmental protection regulations and methods of enforcement.

California's Air Resources Board (CARB) is the strictest regulatory body concerned with pollution in the country. The emissions standards set by CARB are stricter than the federal EPA requirements; specifically with regards to hydrocarbon and nitrogen oxide emissions—which become smog. Older vehicles in California are required to be retrofitted so that they operate cleaner. The gasoline sold in California is also required to have less sulfur, benzene and hydrocarbons than most gasoline sold elsewhere in the United States. CARB also oversees an emissions rating program for cars that are driven and sold in California. Cars can be rated: Low Emission Vehicle (LEV), Ultra Low Emission Vehicle (ULEV), Super Ultra Low Emission Vehicle (SULEV), Partial Zero Emission Vehicle (PZEV), or Zero Emission Vehicle (ZEV). Since 2004, CARB has mandated that every new car sold in California must be a LEV or better. Currently, 16 other states have adopted, or are in the process of adopting, California's strict emissions standards.

Accordingly, there is a need for a fuel system that can provide a low-cost alternative to standard fuel prices that creates less pollution and meets various emissions standards. The present invention fulfills these needs and provides other related advantages.

### SUMMARY OF THE INVENTION

The present invention is directed to a dual fuel system for an internal combustion engine. The system includes a first fuel tank and a second fuel tank. The first fuel tank is in fluid communication with a first fuel inlet on a fuel switch. The second fuel tank is in fluid communication with a second fuel inlet on the same fuel switch. The second fuel inlet is separate and distinct from the first fuel inlet. A fuel outlet on the fuel switch is in fluid communication with a combustion chamber on the engine. The fuel switch is configured to switch between a first state of connecting the first fuel inlet to the fuel outlet and a second state of connecting the second fuel inlet to the fuel outlet.

The system further includes a microcontroller in the fuel switch. A microcontroller is configured to control the fuel switch and selectively switch between the first state and the second state. The control of the fuel switch by the microcontroller is preferably responsive to data received from an engine sensor. The engine sensor may be configured to measure RPMs, temperature, first fuel level, second fuel level, mileage, or duration of engine operating states. The control of the fuel switch by the microcontroller may also be responsive to a selector switch movable between a first position corresponding to the first state and a second position corresponding to the second state.

The system may further include a fuel injector rail disposed between and in fluid communication with both the fuel outlet of the fuel switch and the combustion chamber. A fuel injector may be included on the fuel injector rail so as to be in fluid communication with the combustion chamber. In addition, a plurality of fuel injectors may be included on the fuel injector rail, with each of the plurality of fuel injectors being in fluid communication with one of a plurality of combustion chambers in the engine. The fuel injector and fuel injector rail are preferably configured to operate at ignition temperatures of about nine hundred twenty degrees to one thousand twenty degrees Fahrenheit.

The first fuel tank preferably contains gasoline and the second fuel tank preferably contains propane. The fuel switch may comprise a rotating switch having a central aperture configured to fluidly connect one of the first fuel inlet or the second fuel inlet to the fuel outlet. The rotating switch preferably seals off the second fuel inlet when the central aperture fluidly connects the first fuel inlet to the fuel outlet. Conversely, the rotating switch seals off the first fuel inlet when the central aperture fluidly connects the second fuel inlet to the fuel outlet.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a plan view of an automobile, illustrating a car engine utilizing the dual fuel system of the present invention;

FIG. 2 is a side cut-away view of a car engine, illustrating a fuel injector connected to the dual fuel system of the present invention;

FIG. 3 is a schematic of the dual fuel system, illustrating the flow path of the two types of fuel;

FIG. 4 is an enlarged cut-away view of the switch box of the dual fuel system, illustrating the rotating switch and microcontroller; and

FIG. 5 is an environmental view of the dashboard of a car, illustrating the display and selector switch for the dual fuel system of the present invention.

### DETAILED DESCRIPTION OF THE PREFERRED EMBODIMENTS

The present invention is a dual fuel system for a fuel injected internal combustion engine. In the preferred embodiment, the dual fuel system of the present invention includes a standard gasoline tank, a propane tank, a switch box with a microcontroller, fuel injector rails with fuel injectors, a dashboard display and controller, as well as all the necessary hoses and connectors. The dual fuel system utilizing gasoline and propane responds to the needs described above in several respects. Propane is a widely available, inexpensive fuel source that burns cleanly and efficiently in a car. Few alterations are needed for a standard fuel injected engine to be able to run on propane. Also, the dual fuel system of the present invention enables an automobile user to meet stringent emissions requirements and regulations with a minimum level of inconvenience and expense. The dual fuel system will generally be referred to herein by the numeral 10.

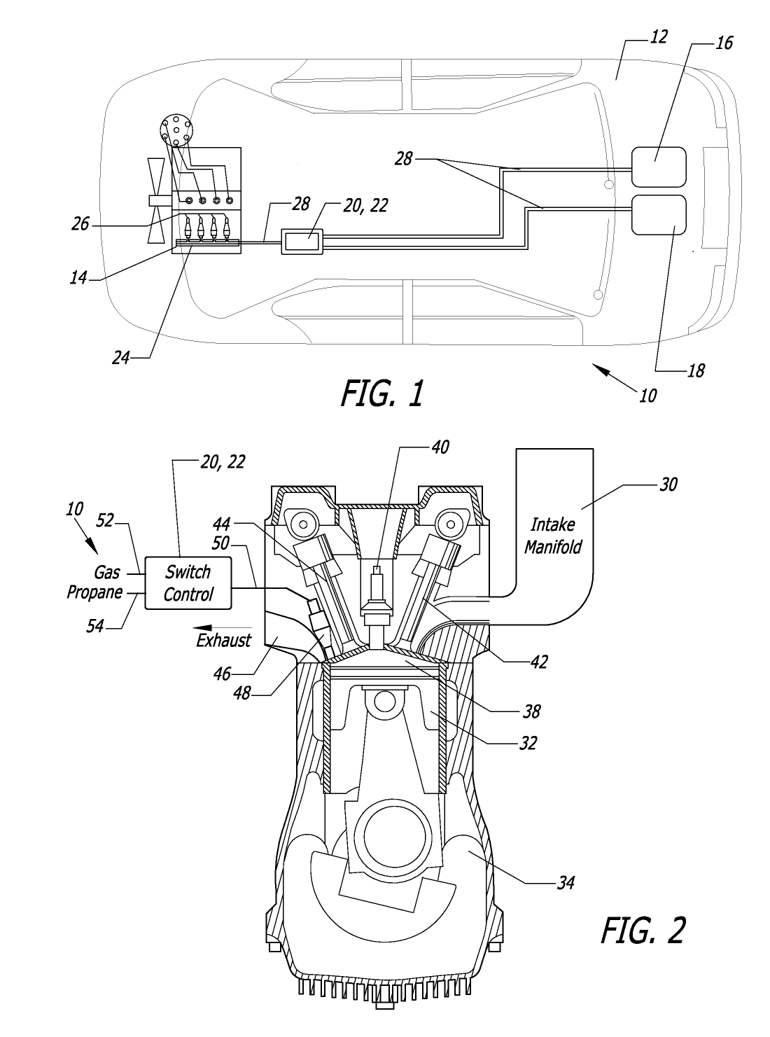

The dual fuel system 10 of the present invention is shown in FIG. 1. Here, a car 12 is shown with an engine 14, a fuel injector rail 24, and four fuel injectors 26. A gasoline tank 16 and a propane tank 18 are connected with hoses 28 to a switch box 20. The switch box 20 also houses a microcontroller 22. The switch box 20 is connected to the fuel injector rail 24 with a hose 28.

Fuel injection systems replaced the old carburetor systems. Carburetors supplied fuel to the engine based on suction while fuel injection systems supply fuel via a direct injection spray. The amount of fuel sprayed into engine's combustion chamber corresponds to the amount of air entering the engine. This means that the fuel injection system makes the engine much more efficient.

Normally, a fuel injection system only functions with one type of fuel. The dual fuel system 10 of the present invention functions with both standard gasoline and liquid propane. The dual fuel system 10 can be retrofitted into an existing car, or it can be factory installed into a new car. The dual fuel system 10 requires both the standard gas tank 16 as well as a separate propane tank 18. The propane tank 18 may be made of carbon fiber, or some other material that is puncture resistant and capable of transporting materials under pressure. In a retrofit, the propane tank 18 may be mounted inside the trunk of the vehicle where the dual fuel system 10 is being used. Alternately, the propane tank 18 may also be mounted on the undercarriage of the car 12, or any other place where the propane tank 18 will fit without compromising the safety and functionality of the car 12.

Propane is a by-product of natural gas processing and petroleum refining. It is most commonly used as fuel for barbecues, portable stoves, and residential central heating. 90% of propane used in the United States is produced in the United States. It also has a relatively high octane rating at 110. This means that propane is relatively clean burning and very stable. Liquid propane gas has a higher ignition temperature of 920-1020 degrees; versus 80-300 degrees for gasoline. It also will only burn with an air-fuel ratio of between 2.2% and 9.6% and will rapidly dissipate beyond its flammability range in the open atmosphere, making it very safe compared to gasoline. Propane is typically less expensive than gasoline and widely available (although not through typical gas stations). Because propane is released as a gas, it does not spill, pool or leave a residue. Also, propane contains almost no carbon. Carbon in gasoline is what turns engine oil black. That means that using propane as a fuel source will vastly prolong the life of a car's engine oil. All-in-all, propane is a very desirable fuel source for use in both personal and commercial vehicles.

A standard gasoline engine can burn propane with very few alterations. The only changes that need to be made are to the fuel injector rail and the fuel injectors. The existing fuel injector rail and fuel injectors must be removed and replaced with the fuel injector rail 24 and fuel injectors 26 of the present invention. These components are configured to handle the range of pressures and temperatures necessary to accommodate both gasoline and propane. The placement of the fuel injector 24 in the engine 14 of a car 12 is illustrated in FIG. 2. Here, a standard engine 14 is illustrated. Air is received through the intake manifold 30 into the combustion chamber 38 as the intake camshaft 42 is drawn up. This creates the vacuum necessary to draw the air in. When the intake camshaft 42 is pushed back down, fuel is injected into the combustion chamber 38 by the fuel injector 48. The fuel injector 48 basically acts as an atomizer, producing a fine spray of fuel that is easily ignited by the spark plug 40. Once the spark plug 40 ignites the fuel, the resulting combustion forces the piston 32 down into the crankcase 34, which in turn rotates the crankshaft (not shown). At this point, the exhaust camshaft 44 draws back to create the vacuum necessary to drive the exhaust out of the combustion chamber 38 through the exhaust manifold 46.

The fuel injector 48 is supplied by the fuel supply line 50. The fuel supply line 50 is, in turn, connected to the switch box 20. The switch box 20 serves to switch back and forth between gasoline and propane. Thus, the switch box 20 has two input supply lines: the gas supply line 52 and the propane supply line 54. The switch box 20 is controlled by a microcontroller 22 housed therein. The microcontroller 22 has a logic circuit (not shown) and receives data inputs from various engine sensors (i.e. RPMs, temperature, etc). The microcontroller 22 causes the fuel that is run through the fuel supply line 50 to switch back and forth between gasoline and propane based on these data inputs. Alternately, the driver of the vehicle may manually switch the fuel source from a switch on the dashboard inside the car (described below). The switch box 20 receives gasoline from the gasoline supply line 52, and propane from the propane supply line 54.

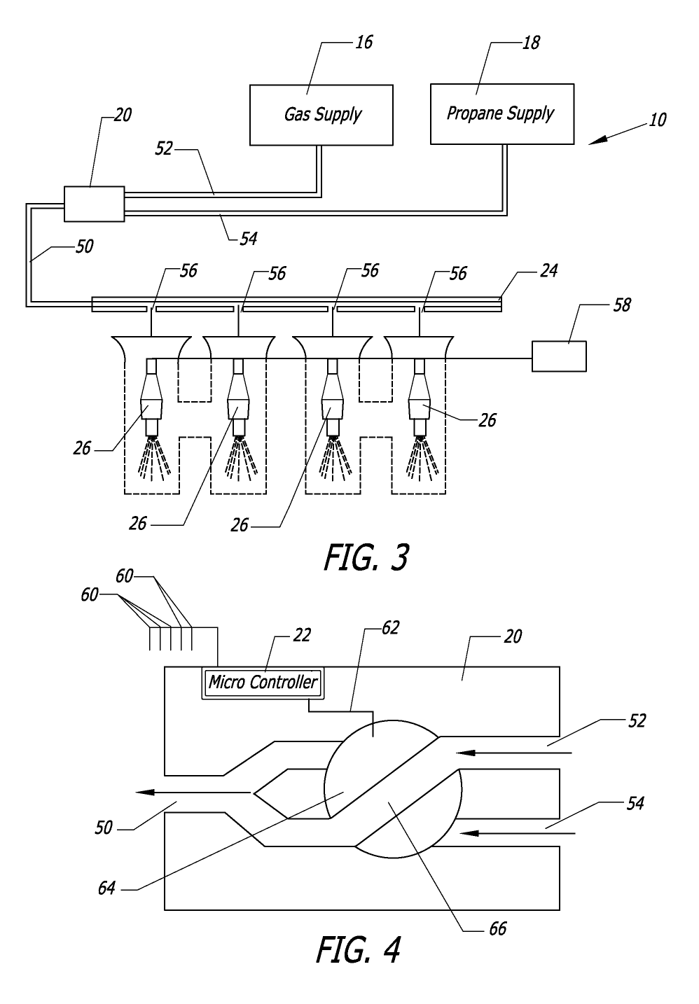

The dual fuel system 10 is illustrated schematically in FIG. 3. Here the gasoline tank 16 and the propane tank 18 are shown connected to the switch box 20 via the gasoline supply line 52 and the propane supply line 54. As described above, the fuel supply line 50 connects the switch box 20 to the fuel injectors 26 via the fuel injector rail 24. The fuel injector rail 24 is basically a pipe with a series of apertures 56. Each aperture 56 is fitted with a fuel injector 26. The seat between each fuel injector 26 and aperture 56 is sealed such that no leaks occur, even at high temperatures and under high pressure. The fuel injector rail 24 serves to deliver fuel to each fuel injector 26 at a consistent pressure so that fuel can be evenly distributed by all fuel injectors 26. The fuel injectors 26 are controlled by an electronic control unit (ECU) 58. The ECU 58 tells the fuel injectors 26 when to inject fuel and how much fuel to inject. The ECU 58 is typically part of the car's computer control system (not shown).

The switchbox 20 is shown in a cut-away side view in FIG. 4. Here, the functionality rotating switch 64 is illustrated. The rotating switch 64 is configured to allow only one type of fuel through to the fuel supply line 50 at a time. The dual fuel system 10 does not mix different fuel types to create a blended fuel. Rather, only one fuel source is burned at a time. The rotating fuel switch 64 ensures that only one type of fuel runs through the switch box 20 at a time. It does this by providing a central aperture 66 that allows for only one type of fuel to pass through the rotating switch 64 at a time. When the rotating switch 64 is positioned such that the central aperture 66 is aligned with the propane supply line 54, the gasoline supply line 52 is completely blocked. Likewise, when the rotating switch 64 is positioned such that the central aperture 66 is aligned with the gasoline supply line 52, the propane supply line 54 is completely blocked. When the central aperture 66 is aligned with either the propane supply line 54 or the gasoline supply line 52, it is also aligned with the fuel supply line 50 at the other end of the switch box 20. In this way, only one type of fuel passes through the switch box 20 at a time.

The rotating switch 66 is controlled by the microcontroller 22. The microcontroller 22 has a series of sensor inputs 60. These sensor inputs 60 carry data from various engine sensors (not shown) and provide the microcontroller 22 with information about the operating environment inside the engine. The microcontroller 22 is connected to the rotating switch 64 via a microcontroller connection 62. In other embodiments of the dual fuel system, the switch box 20 may have a different mechanism other than the rotating switch 64. Regardless of mechanism used, the switch box 20 in any embodiment of the present invention will allow only one type of fuel to pass through at a time.

The microcontroller 22 can be programmed to control the rotating switch 64 so as to maximize the efficiency of the dual fuel system. The microcontroller 22 can be programmed based on time, temperature, or volume. For example, if a driver knows that he will be driving all day, the microcontroller 22 can be programmed to switch from gasoline to propane at a certain time (when the driver knows he will be traveling through an area with more stringent emissions requirements). Likewise, the microcontroller 22 can be programmed to switch from gasoline to propane when the engine temperature reaches a certain point because propane is more stable than gasoline at higher temperatures. The microcontroller 22 can also be programmed to automatically switch to propane when the gas tank 16 is running low, and vice versa. In other embodiments of the dual fuel system 10, the microcontroller 22 can be programmed to switch between fuel sources based on other factors such as RPMs, mileage, geographic location, etc. In this way, the dual fuel system 10 can automatically optimize fuel usage in any type of vehicle. The microcontroller 22 may also be programmed with fail safe procedures in the event of a leak or loss of pressure in the fuel system. In the event that something goes wrong in the fuel system, the microcontroller 22 simply reverts the fuel system back to OEM standards.

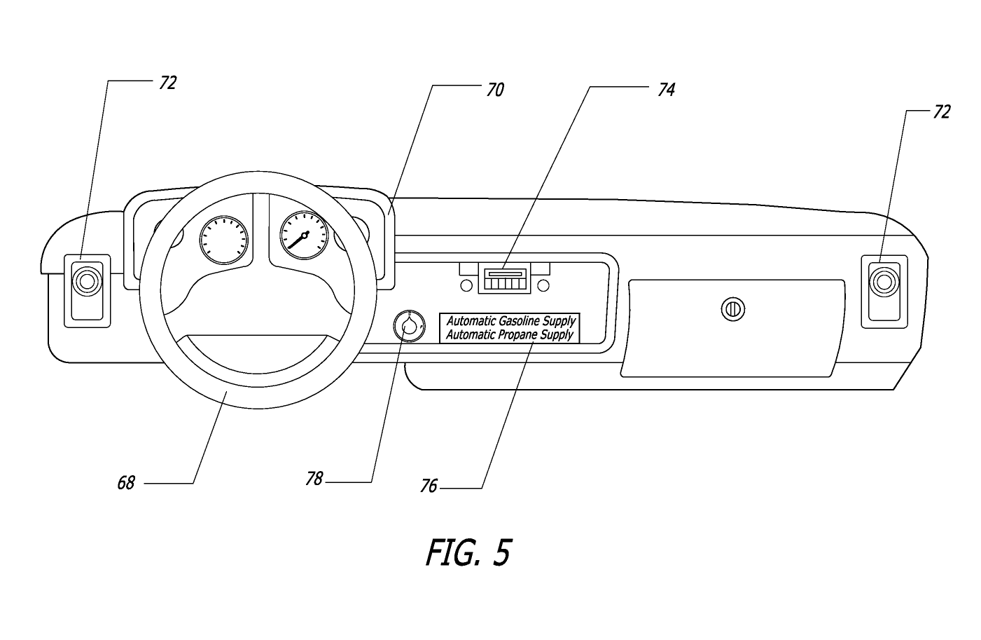

The dual fuel system 10 may also be manually controlled. In FIG. 5, the steering wheel 68 and dashboard 70 of a car are illustrated. Typically, the dashboard 70 is home to air conditioning vents 72 and the radio display and controls 74. The dual fuel system 10 also includes a system display 76 and selector switch 78 that are installed on the dashboard 70 of a car. The system display 76 for the dual fuel system 10 may display such information as: engine conditions, current fuel source, fuel volume (for both propane and gasoline), automatic settings, etc. The selector switch 78 enables the driver to override the automatic programming of the microcontroller 22 (see FIG. 4) and switch fuel sources on the fly. This functionality is useful if the vehicle is being driven from one region with relaxed emissions regulations into another region with more stringent emissions regulations.

Although several embodiments have been described in detail for purposes of illustration, various modifications may be made to each without departing from the scope and spirit of the invention. Accordingly, the invention is not to be limited, except as by the appended claims.

What is claimed is:

1. A dual fuel system for an internal combustion engine, comprising:
a first fuel tank containing a first fuel in fluid communication with a first inlet on a fuel switch;
a second fuel tank containing a second fuel in fluid communication with a second fuel inlet on the fuel switch, wherein said second fuel is different from said first fuel, and said second fuel inlet is separate and distinct from said first fuel inlet;
a fuel outlet on the fuel switch in fluid communication with a combustion chamber in the engine, wherein the fuel switch is configured to switch between a first state connecting the first fuel inlet to the fuel outlet and a second state connecting the second fuel inlet to the fuel outlet.

2. The dual fuel system of claim 1, wherein the first fuel tank contains gasoline and the second fuel tank contains propane.

3. The dual fuel system of claim 1, wherein the fuel switch comprises a rotating switch having a central aperture configured to fluidly connect one of the first fuel inlet or the second fuel inlet to the fuel outlet.

4. The dual fuel system of claim 3, wherein the rotating switch seals off the second fuel inlet when the central aperture fluidly connects the first fuel inlet to the fuel outlet.

5. The dual fuel system of claim 4, wherein the rotating switch seals off the first fuel inlet when the central aperture fluidly connects the second fuel inlet to the fuel outlet.

6. The dual fuel system of any of claims 1-5, further comprising a microcontroller in the fuel switch, the microcontroller configured to control the fuel switch to selectively switch between the first state and the second state.

7. The dual fuel system of claim 6, wherein the microcontroller is responsive to data received from an engine sensor.

8. The dual fuel system of claim 7, wherein the engine sensor is configured to measure engine RPMs, engine temperature, a first fuel level, a second fuel level, distance traveled on a gallon of first fuel or second fuel, or duration of operation of engine on first fuel or second fuel.

9. The dual fuel system of claim 6, wherein the microcontroller is responsive to a selector switch moveable between a first position corresponding to the first state of the fuel switch and a second position corresponding to the second state of the fuel switch.

10. The dual fuel system of any of claims 1-5, further comprising a fuel injector rail disposed between and in fluid communication with both the fuel outlet and the combustion chamber.

11. The dual fuel system of claim 10, further comprising a fuel injector on the fuel injector rail in fluid communication with the combustion chamber.

12. The dual fuel system of claim 11, wherein the system comprises a plurality of fuel injectors on the fuel injector rail, each of the plurality of fuel injectors in fluid communication with a respective one of a plurality of combustion chambers in the engine.

13. The dual fuel system of claim 11, wherein the fuel injector and fuel injector rail are configured to operate at an ignition temperature of about 920° F. to 1020° F.
